(19) United States
(12) Patent Application Publication
(10) Pub. No.: US 2007/0246642 A1
(43) Pub. Date: Oct. 25, 2007

(54) SECURITY AND ENVIRONMENTAL MONITORING SYSTEMS

(76) Inventors: Mark A. Millett, Guilford, CT (US); Robert Michael Errato, Hamden, CT (US)

Correspondence Address: BACHMAN & LAPOINTE, P.C., 900 CHAPEL STREET, SUITE 1201, NEW HAVEN, CT, 06510, US

(21) Appl. No.: 11/379,274

(22) Filed: Apr. 19, 2006

(51) Int. Cl. G06M 7/00

(52) U.S. Cl. 250/221

(57) ABSTRACT

A monitoring system is provided which includes a monitoring device placed within a building. The monitoring system further includes a device for allowing a user/operator to access the monitoring device in real time from a remote location.

### BACKGROUND OF THE INVENTION

(1) Field of the Invention

The present invention relates to a system for monitoring the security and/or the environment of a structural facility such as a home, an office building, a building structure, and the like.

(2) Prior Art

A wide variety of security monitoring systems are known in the art. Similarly, a wide variety of environmental monitoring systems are known in the art.

Given the propensity of people to travel or otherwise be away from structures that use these security and environmental monitoring systems, it is highly desirable for such people to have access to the current status of these structures.

### SUMMARY OF THE INVENTION

Accordingly, it is an object of the present invention to provide a security and/or environmental monitoring system that can be accessed by a user/operator from a remote location.

In accordance with the present system a monitoring system broadly comprises a monitoring device placed within an area in a building and means for accessing the monitoring device in real time from a remote location.

Other details of the security and environmental monitoring systems of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a first embodiment of a monitoring device in accordance with the present invention;

FIG. 2 is a schematic representation of a light detection circuit that may be incorporated into the device of FIG. 1;

FIG. 3 is a schematic representation of an alternative embodiment of a light detection circuit that may be incorporated into the device of FIG. 1;

FIG. 4 is a schematic representation of yet another alternative embodiment of a light detection circuit that may be incorporated into the device of FIG. 1;

FIG. 5 is a schematic representation of a temperature/humidity circuit that may be incorporated into the device of FIG. 1;

FIG. 6 is a schematic representation of an alternative temperature/humidity circuit that may be incorporated into the device of FIG. 1;

FIG. 7 is a schematic representation of an alternative temperature/humidity circuit that may be incorporated into the device of FIG. 1; and

FIG. 8 illustrates an alternative environmental and monitoring system.

### DETAILED DESCRIPTION OF THE PREFERRED EMBODIMENT(S)

The security and environmental monitoring systems of the present invention may be used to monitor the security of and/or the environmental conditions of any building structure including, but not limited to, a house, a manufacturing facility, an apartment, a condominium, and a retail store.

The monitoring system of the present invention uses an environmental and security device 10 that, at a minimum, measures the light level, temperature, and humidity in an area of a building via one or more sensors. The device 10 makes those measured values available to outside programming interfaces so that users/operators can remotely access the measured values. In a first embodiment of the device 10, the device transmits information about the measured values via radio frequency at 310 MHz to a compliant transceiver to which a user/operator has access. In a second embodiment of the device 10, the device transmits the measured values via a connected/query-based 802.11b wireless LAN/WAN network to users/operators. In a third embodiment, the device 10 transmits the measured values via a connected/query-based hard-wired LAN/WAN network to a user/operator.

The environmental and security device 10 of the present invention is different from other devices in that it actually transmits the level of light or LUX in the immediate environment in the area under surveillance, rather than a simple dust or dawn light condition. The actual LUX, when combined with temperature and humidity levels, provides a complete digital environmental snapshot of the area such as a room.

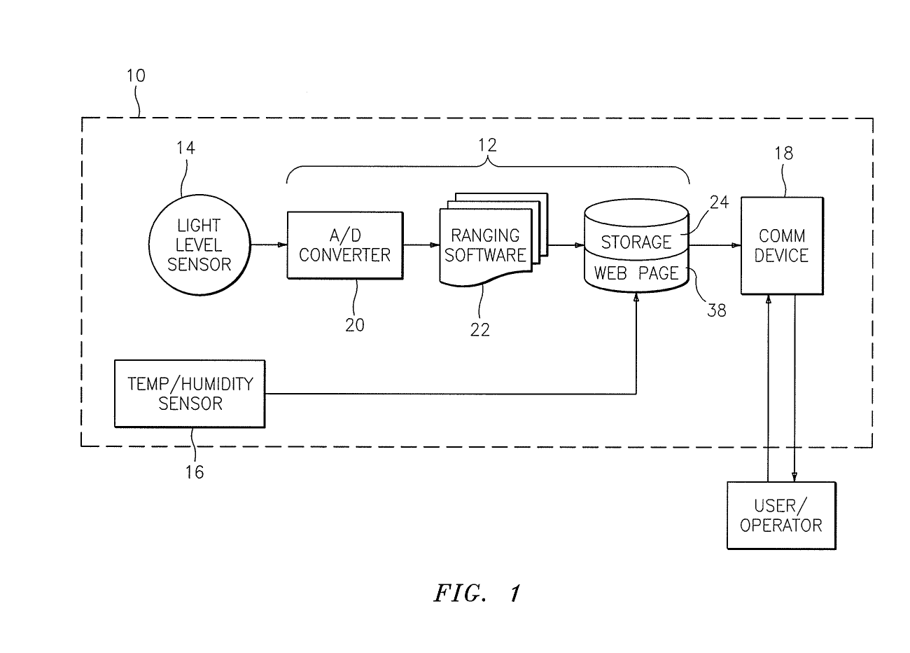

Referring now to FIG. 1, the device 10 may be comprised of a printed circuit board (PCB) that houses a PIC microcontroller 12, sensors 14 and 16, a communication device 18 such as RF transmitter/network interface(s) and supporting circuitry. The PIC microcontroller 12 preferably includes an analog/digital converter 20, a preprogrammed chip 22 having ranging software embedded therein, and a storage device 24. The chip 22 may comprise any suitable chip known in the art. Similarly, the storage device 24 may comprise any suitable storage device known in the art. The device 10 may be powered by either batteries (not shown) or directly by a 12V DC source (not shown). If powered by batteries, the device 10 may check for a battery low condition, and if identified, may transmit the status via the communication device 18 or otherwise make the status known to a user/operator of the system. For example, the device 10 may emit an audible sound or flash a light if the battery is in a low condition.

In the case of the first embodiment of the device 10, the user/operator may set the household and unit codes, which uniquely identify the device 10, using a simple dual bush button system (not shown). One button may be used to set the household code (A-P) and the other button may be used to set the unit code (1-16). An LED (not shown) on the device 10 may blink to confirm the correct codes have been set.

In alternative embodiments of the device 10, the user/operator may set an IP address, a subnet mask, and a default gateway on a web page interface for the device 10. This may be done by a computer operated by the user/operator after access has been gained to the web page interface.

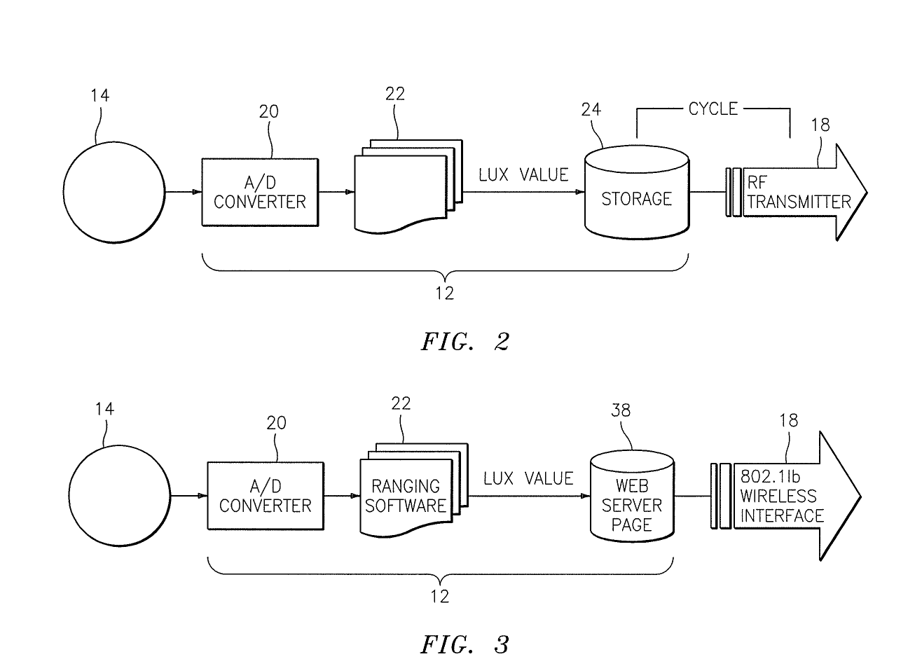

As shown in FIG. 2, a light sensor 14 used by the device 10 to measure light level may be any suitable light sensor known in the art, such as a TOSHIBA photo diode, that generates a low current analog value depicting a lighting level. This value is preferably converted via the analog to digital converter 20 from an analog value to a digital value. The digital value exiting the analog to digital converter 20 is forwarded to the chip 22 containing the ranging software where the digital signal is converted to an equivalent LUX value. The LUX value may be stored by the device 10 in the storage device 24 to await the next transmitting cycle, such as a 15 second transmitting cycle.

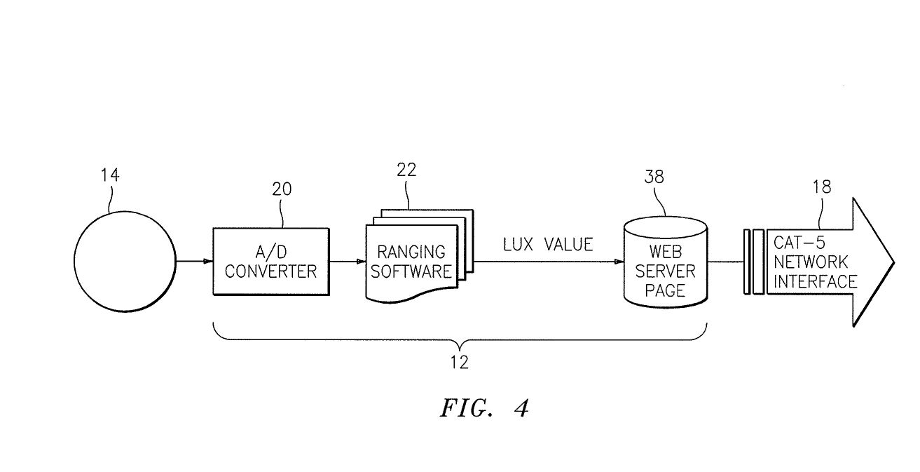

As shown in FIGS. 3 and 4, in alternative embodiments of the device 10, the LUX value may be stored by the device 10 on the device's web page 38 awaiting a query from a user/operator.

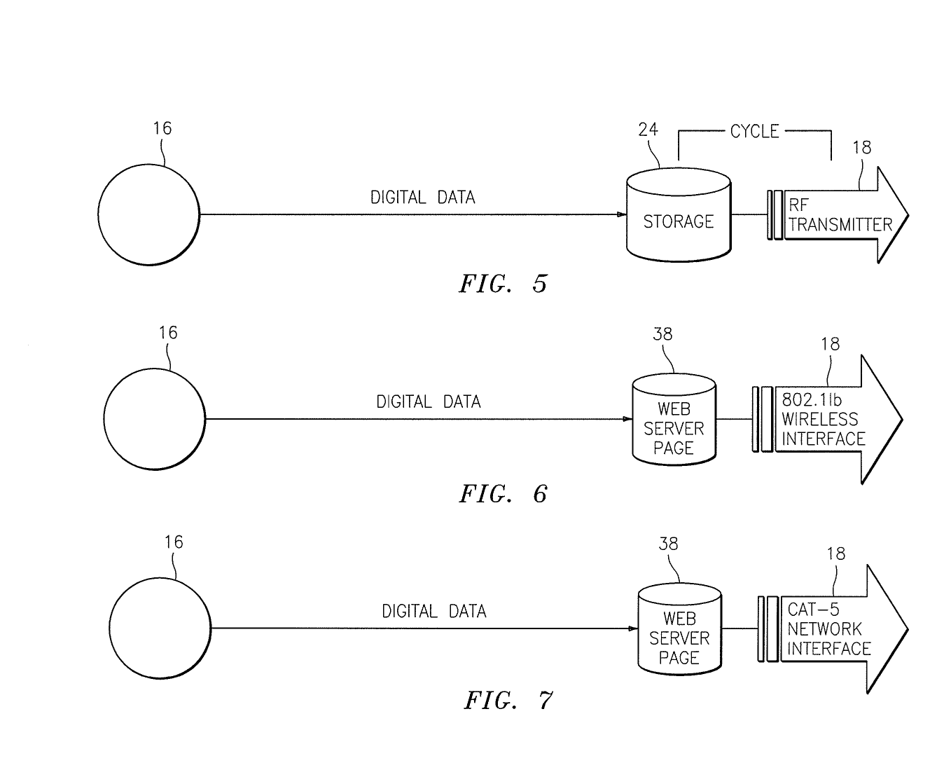

Referring now to FIGS. 5-7, the temperature/humidity sensor 16 used by the device 10 may comprise any suitable sensor or sensors known in the art such as a SENSIRION combination circuit on a single chip. Such a circuit works basically the same as the light sensor 14; however, it provides direct digital data for the measured temperature and humidity, thus requiring no additional analog to digital converter. The digital temperature and humidity values outputted by the sensor 16 are already calibrated to a normalized temperature and humidity level. The temperature and humidity values may be stored by the device 10 either in the storage device 24 as shown in FIG. 5 or on the device's web page 38 as shown in FIGS. 6 and 7.

Alternatively, the monitoring system may include a stand-alone web server based security and environmental monitoring device 100 that provides passive infrared (PIR) movement, CMOS images, ambient lighting level (LUX), ambient temperature, relative humidity, gas detection, smoke detection, oxygen level, carbon monoxide level, other odor/vapor/air quality detection, excessive heat detection, and glass breaking detection through a series of embedded analog and digital sensors. In a preferred embodiment, the device 100 makes those measured values available, in real time, to an operator/user via one or more outside programming interfaces via a web server page 102 on the device 100. The device 100 provides a complete and accurate digital environmental snapshot of an area or room within a building structure.

The security and environmental device 100 can be interfaced to any programming language that can access a local area network (LAN) 104 or a wide area network (WAN) 106. This can be accomplished either through the language's web interface (HTTP/XML-TCP-IP/UDP) or through a dynamic link library (DLL), by simply providing the IP address of the security and environmental monitoring device 100. Once the interface has been achieved, the user/operator through a remote device 107 or 109, such as a computer, a PDA, a cell phone, and a pager, has available the real time values of any of the continuous base sensors (e.g. image, temperature, humidity, light level) integrated into the monitoring device 100 via XML queries, as well as, an immediate user datagram packet (UDP) alert for alert based sensors (e.g. movement, gas, smoke, carbon monoxide, oxygen level, odor/vapor/air quality, excessive heat, glass breaking, etc.) This open systems approach to the monitoring device 100 breaks the proprietary nature of current security and environmental control business, by providing a generic, non-proprietary based, program independent connectivity scheme.

The uses of the monitoring device 100 are many and include environmental control, security, and external device control to name but a few. In an environmental control area, the monitoring device 100 can provide the temperature, humidity and light level to a user/operator. The user/operator, via the LAN 104 or via a DSL/Cable Modem 111 and the WAN 106 may use the real time values produced by the monitoring device 100 to adjust the heating, air conditioning, and lighting in an area or room, as well as automatically turn on lights in a dark area or room when movement is detected or notify the appropriate authorities in the event of motion, gas, odor, vapor, poor air quality, excessive heat, smoke or glass breaking detection. The built in image sensor option may be used to record the area of detection of an unwanted movement in high resolution JPEG/MPEG video.

The monitoring device 100 also includes an input/output block 108 that can be used to connect to any external device 103 known in the art that will react to an open or grounded circuit. A simple example of this is a locking device on a door or case. If the door is opened by an unauthorized person, a signal may be sent to the input 110 of the input/output block 108. The monitoring device 100 may have a controller 112 that is programmed to send an alert signal to a user/operator when such a signal is inputted into the input/output block 108. Similarly, the external device 103 may be an electronic gate may be connected to the output 114 of the input/output block 108. The user/operator may trigger the block 108 so that the monitoring device 100 will either open or ground a circuit resulting in the opening or closing of the gate.

The monitoring device 100 can be powered by a 110 AC source (not shown), a distributed 12V DC source (not shown) or by a 12V DC power supply (not shown). The monitoring device 100 has a user assignable IP address, a subnet mask and a default gateway located on the device's web page interface 102 that is preferably located in an embedded web server 116. Access to the web page interface 102 may be gained by a user/operator from a remote location using a remote device 107 or 109 and the LAN network 104 or the WAN network 106. The user/operator then has access to the real time measured values. If desired, the user/operator may access the web page 102 to program and/or change threshold values for various sensed parameters so that when the programmed/changed threshold value is reached, an alert signal may be sent to a remote device 107 or 109 such as his/her computer, PDA device, cell phone, an e-mail receiving device, and/or pager. If the desired, the alert signal may be transmitted to a police station, the fire department, an alarm monitoring company, etc.

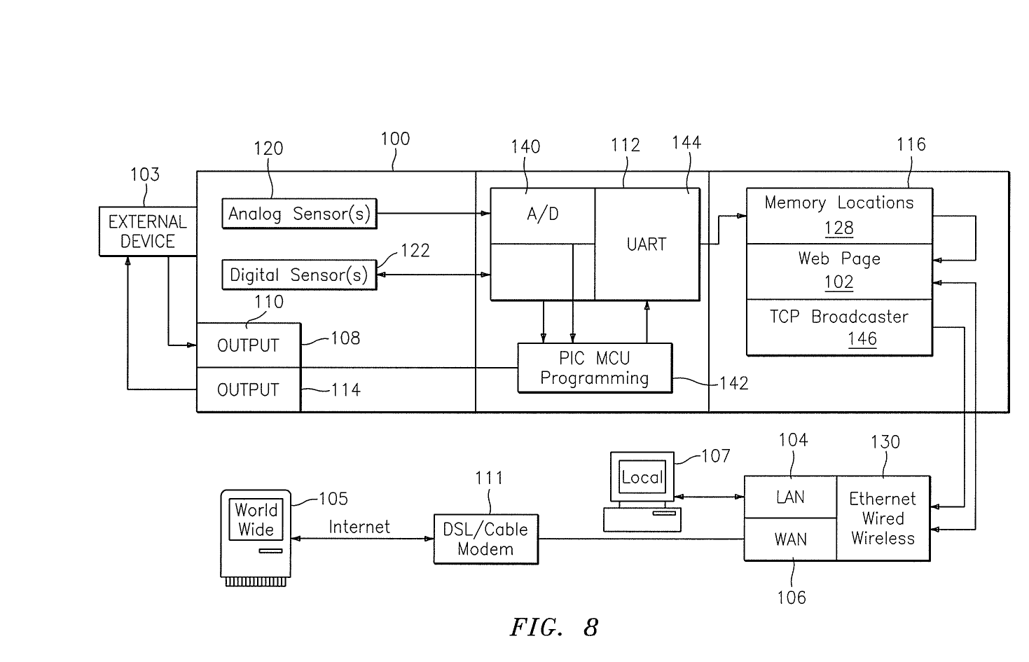

Referring now to FIG. 8, the monitoring device 100 may be comprised of one or more printed circuit boards that house one or more analog sensors 120 and one or more digital sensors 122, a micro controller unit (MCU) 112 having an analog/digital converter 140, a PIC MCU programmed module 142 containing the programming for the unit 112 and a Universal Asynchronous Receive Transmitter (UART) 144, the embedded web server 116 with a storage device 128 with a plurality of memory locations, the web server page 102, and a TCP broadcaster 146 for sending packets of information over the Internet such as alerts, e-mails, etc., a network 802.x Ethernet interface (wired RJ45 and wireless 802.11b) 130 and supporting LED and circuits. The 802.11 may be used to send e-mails based on sensor thresholds. The UART 144 may be used to communicate between the PIC processor's ranged/non-ranged sensor values to the web page. The MCU 112 preferably contains within the module 142 a control program that monitors the digital and analog sensors 120 and 122. In the case of continuous based sensors (e.g. image, temperature, humidity, light level, carbon monoxide, oxygen level, etc.), the MCU 112 preferably updates the memory locations 128 of the embedded site web server 116 with the sensor measured values. These memory locations 128 may be mapped to the corresponding sensor values depicted on the monitoring device's web page 102. The memory locations 128 containing the stored measured values are preferably available to XML queries generated by the user/operator. In the case of sensors that are event/detection based (e.g. motion, smoke, excessive heat, gas, glass breaking, etc.), the MCU 112 control program may be used to update the web page 102 and to instantaneously send a user datagram package (UDP) to any listening program available to the user/operator. The UDP may notify the listening program as to the sensor type, location, and severity of the detection. The UDP may be transmitted to a computer, a PDA device, a pager, a cell phone, a police station, a fire department, an alarm monitoring entity, etc.

The monitoring device 100 may also have a Setup Page as well as the monitoring page. The setup page includes a user definable device name/lection, an IP address, a subnet mask, a default gateway, a SMTP (sample mail transport protocol) server, up to three e-mail address alerts, and sensor names/thresholds.

One of the principal advantages to the systems of the present invention is the user interface application (UIA) that monitors the monitoring device 10 or 100. The UIA may be located locally or anywhere in the world that has Internet connectivity and access rights. Thus, a user/operator on vacation in Australia could check the light level, temperature, humidity in his/her home, office, or manufacturing facility and send signals to other devices to adjust the light level, to lower or raise the temperature, and/or to operate a dehumidifier. Alert signals sent by the device 10 or 100 to the user/operator allow the user/operator to take prompt action to respond to the detected event. For example, upon receiving a signal that indicates an unauthorized entry to the room/area/building, the user/operator may notify appropriate agencies to respond to the unauthorized entry.

It is apparent that there has been provided in accordance with the present invention security and environmental monitoring systems that fully satisfy the objects, means, and advantages set forth hereinbefore. While the present invention has been described in the context of specific embodiments thereof, other unforeseeable alternatives, modifications, and variations may become apparent to those skilled in the art having read the foregoing description. Accordingly, it is intended to embrace those alternatives, modifications, and variations as fall within the broad scope of the appended claims.

What is claimed is:

1. A monitoring system for a building comprising:
a monitoring device placed within a selected area; and
means for accessing said monitoring device in real time from a remote location.

2. The monitoring system according to claim 1, wherein said monitoring device comprising means for sensing light level within said area and for generating a signal representative of said light level and means for converting said to a LUX level signal.

3. The monitoring system according to claim 2, wherein said converting means comprises an analog/digital converter for receiving said signal representative of said light level and for generating a digital signal representative of said light level and means for converting said digital signal to said LUX level signal.

4. The monitoring system according to claim 3, wherein said digital signal converting means comprises a preprogrammed chip containing a ranging program.

5. The monitoring system according to claim 2, wherein said light level sensor comprises a photodiode.

6. The monitoring system according to claim 2, further comprising means for storing said LUX level signal.

7. The monitoring system according to claim 6, wherein said access means comprises means for periodically transmitting said LUX light level to a user at a remote location.

8. The monitoring system according to claim 6, wherein said storing means comprises a web page within said monitoring device.

9. The monitoring system according to claim 8, wherein said accessing means comprises means for periodically transmitting a signal representative of said LUX light level from said web page to a user at a remote location.

10. The monitoring system according to claim 1, wherein said monitoring device comprises means for sensing temperature and humidity within said area and generating a signal representative of said sensed temperature and humidity and means for storing said signal representative of said sensed temperature and humidity.

11. The monitoring system according to claim 10, wherein said accessing means comprises means for periodically transmitting said stored signal representative of said sensed temperature and humidity to a user at a remote location.

12. The monitoring system according to claim 11, wherein said transmitting means comprises an RF transmitter.

13. The monitoring system according to claim 11, wherein said transmitting means comprises a wireless transmitting device.

14. The monitoring system according to claim 11, wherein said transmitting means comprises network interface means for transmitting said stored signal to said user and for allowing said user to query said storage means.

15. The monitoring system according to claim 14, wherein said storage means comprises a web page within said monitoring device.

16. The monitoring system according to claim 1, wherein said monitoring device comprises a plurality of sensors for detecting at least two parameters selected from the group consisting of light level, humidity, temperature, movement, carbon monoxide level, oxygen level, excessive heat, glass breaking, and odor/vapor/air quality within said area and for generating signals representative of said at least two detected parameters and an embedded web server having a web page thereon for storing said generated signals.

17. The monitoring system according to claim 16, wherein said embedded server has at least one memory location and said monitoring device further comprises a controller unit for receiving said signals from said sensors and for transmitting said signal to said memory locations.

18. The monitoring system according to claim 17, wherein said monitoring device further comprises an input/output block connected to said controller unit for receiving an input signal from a first device external to said monitoring device and for generating an output signal to either said first external device or a separate second external device.

19. The monitoring system according to claim 18, wherein said embedded web server includes a TCP broadcaster for sending packets of information over the Internet.

20. The monitoring system according to claim 18, wherein said embedded web server comprises means for generating an alert signal to a remote device if one of said signals exceeds a threshold.

21. The monitoring system according to claim 18, wherein said remote device is selected from the group consisting of a computer, a PDA, a phone, a pager, and means for receiving e-mail.

22. The monitoring system according to claim 16, wherein said accessing means comprises means for querying said web page about real time sensed values.

23. The monitoring system according to claim 16, wherein said accessing means comprises means for setting thresholds for values to be measured.

24. The monitoring system according to claim 16, wherein said accessing means comprises a remote device and a LAN network for allowing a user to access said web page.

25. The monitoring system according to claim 24, wherein said remote device is selected from the group consisting of a computer, a PDA, a phone, and a pager.

26. The monitoring system according to claim 16, wherein said accessing means comprises a remote device and a WAN network for allowing a user to access said web page.

27. The monitoring system according to claim 26, wherein said remote device is selected from the group consisting of a computer, a PDA, a phone, and a pager.
